(19) United States
(12) Patent Application Publication
(10) Pub. No.: US 2025/0155350 A1
(43) Pub. Date: May 15, 2025

(54) METHOD AND SYSTEM FOR IMPLEMENTING ELECTROLYTE MONITORING, COMPUTER STORAGE MEDIUM, AND TERMINAL

(71) Applicant: VRB Energy Inc., Grand Cayman (KY)

(72) Inventors: Shuai Dong, Beijing (CN); Qiming Ge, Beijing (CN); Huichao Liu, Beijing (CN); Zhe Wang, Beijing (CN); Mingyang Yuan, Beijing (CN)

(21) Appl. No.: 18/777,117

(22) Filed: Jul. 18, 2024

(30) Foreign Application Priority Data
Nov. 13, 2023 (CN) 202311497964.7

(51) Int. Cl. G01N 15/0205; G01N 15/00; H01M 8/04276; H01M 8/18

(52) U.S. Cl. CPC G01N 15/0211; H01M 8/04283; H01M 8/188; G01N 2015/0011; G01N 2015/0222

(57) ABSTRACT

Disclosed in the present application are a method and system for implementing electrolyte monitoring, a computer storage medium, and a terminal. The method includes: acquiring an electrical signal including light intensity information by a first laser measuring device that is disposed in advance, the light intensity information including information of light intensity of laser light scattered after passing through an electrolyte including bubbles; determining a bubble particle size distribution function according to the acquired electrical signal; and calculating an instantaneous void volume of the electrolyte according to the determined bubble particle size distribution function, wherein the first laser measuring device is disposed at a position where the scattered light intensity of the laser light passing through the electrolyte can be measured. In an embodiment of the present disclosure, a first laser measuring device is provided to acquire the information of light intensity of laser light scattered after passing through the electrolyte, the bubble particle size distribution function is determined by means of the acquired electrical signal, the instantaneous bubble volume of the electrolyte is calculated by means of the determined bubble particle size distribution function, enabling a gas content of an electrolyte in a flow battery system to be monitored.

### RELATED APPLICATIONS

This application claims priority to Chinese Patent Application No. 202311497964.7, filed Nov. 13, 2023, and titled METHOD AND SYSTEM FOR IMPLEMENTING ELECTROLYTE MONITORING, COMPUTER STORAGE MEDIUM, AND TERMINAL, which is incorporated herein by reference in its entirety.

### TECHNICAL FIELD

The present application relates to, but not limited to, energy storage battery technology, and in particular to a method and system for implementing electrolyte monitoring, a computer storage medium, and a terminal.

### BACKGROUND

As new clean energy gradually replaces traditional energy, energy storage systems have a strut-type effect on the whole new power generation industry as an indispensable link in the new clean energy systems. Since new clean power generation energy (for example, wind power, solar power, etc.) is greatly affected by natural environmental factors, it is difficult to continuously output stable and safe electric energy, so that it is very important to use energy storage batteries as a connection part in the new power generation energy. In the field of energy storage batteries, vanadium flow batteries are widely used in the energy storage industry because they are highly stable and safe, and at the same time, their power carrying capacity, service life and long-term discharge capabilities are far superior to other energy storage devices such as lithium batteries, pumped storage, and air compression storage.

A flow rate of an electrolyte entering a battery stack directly affects the reaction efficiency of the battery stack. If the flow rate of the electrolyte entering the battery stack is too small, the reaction concentration of an active material will be reduced, and the concentration polarization will be increased, which may reduce the efficiency of the flow battery system. If the flow rate of the electrolyte entering the stack is too large, but the reaction interface area is constant, and the amount of the active material participating in the reaction is constant, the too large flow rate will cause the active material not participating in the reaction to circulate back to a liquid storage tank and be unable to participate in the charge or discharge reaction. The flow rate of the electrolyte entering the stack is too large due to the excessive power of the circulation pump, which also reduces the efficiency of the entire flow battery system. In addition, the too large flow rate of the electrolyte entering the battery stack is a huge challenge for the mechanical structural strength of the entire circulation pipe and the inside of the battery stack, and may reduce the cycle life of the battery stack.

When the flow battery is operated for the first time, it is necessary to continuously circulate the circulation pump to remove the air in the circulation pipe and the battery stack. However, the air in the circulation pipe and the battery stack is not necessarily completely removed and discharged. Also, in the positive and negative electrode reaction interfaces of the battery stack, there are often reactions such as hydrogen evolution and oxygen evolution. Hydrogen gas and oxygen gas generated by the reactions are partially adsorbed on a solid-liquid interface and partially dissolved in the electrolyte, and circulate in the pipe along with the electrolyte.

If a large amount of gas is always dissolved in the electrolyte and operated for a long period of time, the following problems arise:
1. When dissolved gas exists in the electrolyte in the circulation pipe, under certain pressure and temperature conditions, the gas often exists in the form of bubbles in the electrolyte. If the content of bubbles is too large, causing the suction vacuum degree to be higher than an allowable vacuum degree, then cavitation will occur. The hazards manifested are mainly as follows:
   1) generation of noise and vibration of 600 to 25000 Hz; 2) reduction of flow rate, head and efficiency; 3) fatigue damage of metal; and 4) chemical corrosion caused by bubble condensation and exothermic heat (the increase in outlet pressure dissolves bubbles, so the liquid at the pump outlet does not contain bubbles).
2. The hydrogen evolution reaction of the electrolyte will reduce the hydrogen ion content in the electrolyte, resulting in the loss of hydrogen ions during the charge and discharge reaction, leading to battery capacity attenuation. Also, a part of hydrogen gas and oxygen gas bubbles are adsorbed on the reaction interface, resulting in a reduction in the available reaction interface area, and a reduction in the coulomb and energy efficiency of the battery.
3. After the generated hydrogen gas and oxygen gas flow with the circulating electrolyte and reach the liquid storage tank, a part of the gases may precipitate out of the electrolysis and accumulate above the liquid level of the storage tank. If too much hydrogen gas accumulates, the concentration reaches an adjacent value, which may cause a safety accident.

In the flow battery system in the related art, the gas content in the electrolyte is not detected in real time, so that the amount of dissolved gas in the electrolyte cannot be known. How to monitor the gas content of the electrolyte in the flow battery system becomes a problem to be solved.

### SUMMARY

The following is a summary of the subject matter described in detail in the present application. This summary is not intended to limit the scope of protection of the claims.

Embodiments of the present disclosure provide a method and system for implementing electrolyte monitoring, a computer storage medium, and a terminal, which can monitor the gas content of an electrolyte in a flow battery system.

An embodiment of the present disclosure provides a method for implementing electrolyte monitoring, comprising:
acquiring an electrical signal comprising light intensity information by a first laser measuring device that is disposed in advance, the light intensity information comprising information of light intensity of laser light scattered after passing through an electrolyte containing bubbles;
determining a bubble particle size distribution function according to the acquired electrical signal; and
calculating an instantaneous void volume of the electrolyte according to the determined bubble particle size distribution function;
wherein the first laser measuring device is disposed at a position where the scattered light intensity of the laser light passing through the electrolyte can be measured.

In another aspect, an embodiment of the present disclosure further provides a computer storage medium, storing a computer program therein, wherein when the computer program is executed by a processor, the method for electrolyte monitoring described above is implemented.

In yet another aspect, an embodiment of the present disclosure further provides a terminal, comprising a memory and a processor, a computer program being saved in the memory, wherein
the processor is configured to execute the computer program in the memory; and
when the computer program is executed by the processor, the method for electrolyte monitoring described above is implemented.

In still another aspect, an embodiment of the present disclosure further provides a system for implementing electrolyte monitoring, comprising a first laser measuring device, a determination unit and a processing unit, wherein
the first laser measuring device is disposed in advance at a position where scattered light intensity of laser light passing through an electrolyte can be measured, and configured to acquire an electrical signal comprising light intensity information, the light intensity information comprising information of light intensity of laser light scattered after passing through the electrolyte containing bubbles;
the determination unit is configured to determine a bubble particle size distribution function according to the acquired electrical signal; and
the processing unit is configured to calculate an instantaneous void volume of the electrolyte according to the determined bubble particle size distribution function.

Compared with the related art, the present application includes: acquiring an electrical signal comprising light intensity information by a first laser measuring device that is disposed in advance, the light intensity information comprising information of light intensity of laser light scattered after passing through an electrolyte containing bubbles; determining a bubble particle size distribution function according to the acquired electrical signal; and calculating an instantaneous void volume of the electrolyte according to the determined bubble particle size distribution function, wherein the first laser measuring device is disposed at a position where the scattered light intensity of the laser light passing through the electrolyte can be measured. In an embodiment of the present disclosure, a first laser measuring device is provided to acquire the information of light intensity of laser light scattered after passing through the electrolyte, the bubble particle size distribution function is determined by means of the acquired electrical signal, the instantaneous bubble volume of the electrolyte is calculated by means of the determined bubble particle size distribution function, enabling a gas content of an electrolyte in a flow battery system to be monitored.

Other features and advantages of the present application will be set forth in the following description, and in part will become apparent from the description, or may be understood by means of the implementation of the present application. Other advantages of the present application will be achieved and attained by means of the solutions described in the description and the accompanying drawings.

### BRIEF DESCRIPTION OF THE DRAWINGS

The accompanying drawings are used to provide an understanding of the technical solutions of the present application and constitute a part of the specification, and together with the embodiments of the present application, are used to explain the technical solution of the present application and not to limit the technical solution of the present application.

FIG. 1 is a flowchart of a method for implementing electrolyte monitoring according to an embodiment of the present disclosure;

FIG. 2 is a schematic diagram of a setting position of a first laser measuring device according to an embodiment of the present disclosure;

FIG. 3 is a schematic structural diagram of the composition of a first laser measuring device according to an embodiment of the present disclosure;

FIG. 4 is a schematic diagram of the installation of a first laser measuring device and a second laser measuring device according to an embodiment of the present disclosure;

FIG. 5 is a schematic diagram of a system for implementing electrolyte monitoring according to an embodiment of the present disclosure; and

FIG. 6 is a structural block diagram of a system for implementing electrolyte monitoring according to an embodiment of the present disclosure.

### DETAILED DESCRIPTION

A plurality of embodiments are described in the present application, but the description is illustrative rather than limiting. Moreover, it will be apparent to those of ordinary skill in the art that more embodiments and implementations are possible within the scope encompassed by the embodiments described in the present application. Although many possible combinations of features are shown in the accompanying drawings and discussed in the Detailed Description, many other combinations of the disclosed features are possible. Unless expressly limited otherwise, any feature or element of any embodiment may be used in conjunction with or in place of any other feature or element of any other embodiment.

The present application includes and contemplates combinations of features and elements known to those of ordinary skill in the art. The embodiments, features and elements that have been disclosed in the present application may also be combined with any conventional feature or element to form a unique inventive solution as defined by a claim. Any feature or element of any embodiment may also be combined with features or elements from other inventive solutions to form another unique inventive solution as defined by a claim. Therefore, it should be understood that any of the features shown and/or discussed in the present application may be implemented separately or in any suitable combination. Therefore, the embodiments are not limited except as limited by the appended claims and their equivalents. Further, various modifications and changes can be made within the scope of protection of the appended claims.

Further, while representative embodiments are depicted, the description may have presented a method and/or process as a specific sequence of steps. However, to the extent that the method or process does not rely on the specific order of steps described herein, the method or process should not be limited to the specific order of steps described. As those of ordinary skill in the art will appreciate, other sequences of steps are possible. Therefore, the specific order of steps set forth in the description should not be construed as limitations on the claims. Further, the claims directed to the method and/or process should not be limited to performing their steps in the order written. Those skilled in the art may readily appreciate that these orders may vary and still remain within the spirit and scope of the embodiments of the present application.

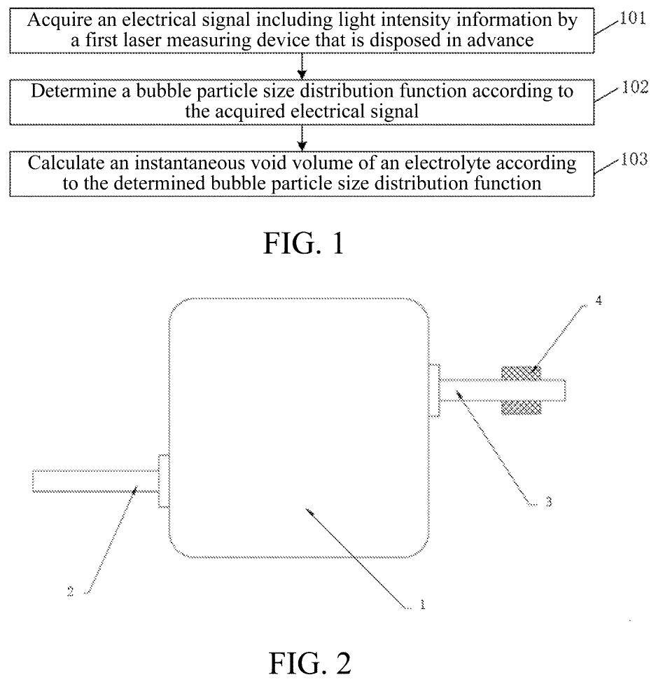

FIG. 1 is a flowchart of a method for implementing electrolyte monitoring according to an embodiment of the present disclosure. As shown in FIG. 1, the method includes:
step 101, acquiring an electrical signal including light intensity information by a first laser measuring device that is disposed in advance, the light intensity information including information of light intensity of laser light scattered after passing through an electrolyte containing bubbles;
step 102, determining a bubble particle size distribution function according to the acquired electrical signal; and step 103, calculating an instantaneous void volume of the electrolyte according to the determined bubble particle size distribution function;
wherein the first laser measuring device is disposed at a position where the scattered light intensity of the laser light passing through the electrolyte is measured.

In an embodiment of the present disclosure, a first laser measuring device is provided to acquire the information of light intensity of laser light scattered after passing through the electrolyte, the bubble particle size distribution function is determined by means of the acquired electrical signal, the instantaneous bubble volume of the electrolyte is calculated by means of the determined bubble particle size distribution function, enabling a gas content of an electrolyte in a flow battery system to be monitored.

In an illustrative example, determining bubble particle size distribution function information according to the acquired electrical signal includes:
pre-processing and demodulating the electrical signal to obtain a demodulated signal; and
determining the bubble particle size distribution function according to the obtained demodulated signal.

In an illustrative example, the pre-processing of the embodiment of the present disclosure may include filtering and amplification. Here, the pre-processing performed on the electrical signal may be implemented by those skilled in the art with reference to the related principle of signal processing. The pre-processing is mainly performed to reduce noise and interference and amplify an effective signal, and the processing accuracy and quality of the signal may be improved by means of the pre-processing.

In an illustrative example, how to demodulate the pre-processed electrical signal to obtain the demodulated signal in the embodiment of the present disclosure may be implemented with reference to the related technology of signal processing. After obtaining the demodulated signal, those skilled in the art may obtain the bubble particle size distribution function according to the demodulated signal with reference to the related principle. The demodulation and the processing of obtaining the bubble particle size distribution function are not limited in the embodiment of the present disclosure.

In an illustrative example, the instantaneous void volume in the embodiment of the present disclosure is sins, and the instantaneous void volume in the embodiment of the present disclosure may be calculated by the following calculation formula:

$$ε ins = n ( R ) \cdot V = n ( R ) \cdot ( 4 / 3 ) π {R}^{3}$$

where n(R) is a particle size distribution function of bubbles, R is the radius of a bubble particle, V is a volume of the bubble particle, and the included angle formed by the propagation direction of scattered light after the laser light is refracted and the propagation direction of a principal light beam is θ, and θ and the radius R of the bubble particle in the electrolyte satisfy:

$$I ( θ ) = \frac{1}{θ} {\int }_{0}^{1} {R}^{2} * n ( R ) {J}_{1}^{2} ( θ RK ) dR ,$$

where I(θ) is the light intensity of the laser light scattered at an angle θ, K=2π/λ, λ is the wavelength of the laser light, and JI is a Bayesian function of a first type.

In an illustrative example, the first laser measuring device in the embodiment of the present disclosure may be disposed at any one of the following positions:
a tube wall of an electrolyte inlet tube of a battery stack;
a tube wall of an electrolyte outlet tube of the battery stack; and
on a branch tube wall of a main inlet and outlet tube of the electrolyte.

In an illustrative example, according to the embodiment of the present disclosure, with reference to FIG. 2, the first laser measuring device 4 may be disposed on a tube wall of an electrolyte inlet tube 2 or an electrolyte outlet tube 3 of a battery stack 1, or on a branch tube wall (not shown in the figure) of a main inlet and outlet tube of the electrolyte.

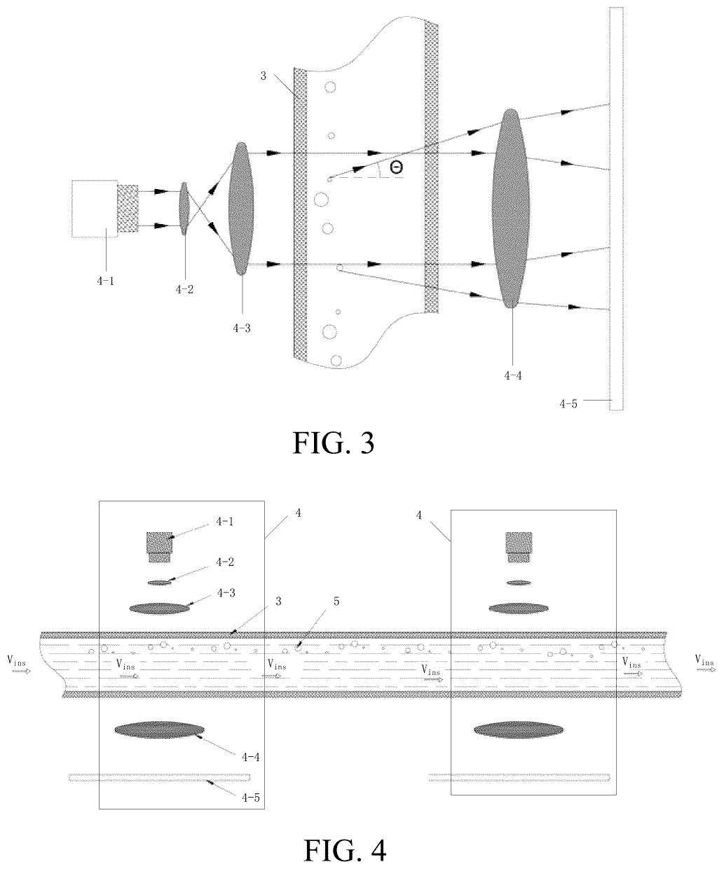

The first laser measuring device 4 of the embodiment of the present disclosure may be an existing device in the related art. With reference to FIG. 3, the first laser measuring device 4 includes a laser 4-1. The laser 4-1 is a unit for emitting laser light. When an electrolyte containing bubbles flows through the laser 4-1, the laser light emitted from the laser will be refracted due to the presence of the bubbles. The propagation direction of the scattered light after the refraction of the laser light forms an included angle θ with the propagation direction of a principal light beam. The size of the angle θ is related to the size of the bubbles. The larger the bubbles, the smaller the angle θ of the generated scattered light, and the smaller the bubbles, the larger the angle θ of the generated scattered light. On the propagation path of the laser 4-1, the first laser measuring device further includes a spatial filter 4-2, a collimator lens 4-3, a Fourier lens 4-4, and a photodetector 4-5. The generated laser light passes through the spatial filter 4-2 to remove multi-order energy peaks to obtain a clean Gaussian light beam, and the filtered Gaussian light beam passes through the collimator lens 4-3 to become a parallel light beam. The parallel light beam is optically filtered by the Fourier lens 4-4, and after the optically filtered parallel light beam is acquired by the photodetector, optical information of the acquired parallel light beam is converted into the electrical signal described above.

In an illustrative example, in addition to performing the bubble volume calculation by the first laser measuring device, the method according to the embodiment of the present disclosure includes:
acquiring a first feedback signal of the laser light incident on the electrolyte by the first laser measuring device;
acquiring a second feedback signal of the laser light incident on the electrolyte by a second laser measuring device that is disposed in advance;
performing a cross-correlation operation with respect to the first feedback signal and the second feedback signal, and solving a time taken for displacement of the electrolyte from upstream to downstream according to a correlation function obtained by the cross-correlation operation; and
according to the time taken for displacement of the electrolyte from upstream to downstream and a spacing between the first laser measuring device and the second laser measuring device, determining a flow speed of the electrolyte;
wherein the second laser measuring device is disposed upstream or downstream of the first laser measuring device, and the first laser measuring device and the second laser measuring device are spaced apart by a preset distance.

In the embodiment of the present disclosure, the determination of the flow speed of the electrolyte is implemented in a non-contact manner by providing the first laser measuring device and the second laser measuring device, and the monitoring process is prevented from being contaminated by the electrolyte while ensuring the accuracy of the measurement result.

In an illustrative example, after determining the flow speed of the electrolyte, the method according to the embodiment of the present disclosure further includes: according to the determined flow speed of the electrolyte and a predetermined pipe cross-sectional area, determining an instantaneous flow rate of the electrolyte.

FIG. 4 is a schematic diagram of the installation of a first laser measuring device and a second laser measuring device according to an embodiment of the present disclosure, wherein the first laser measuring device and the second laser measuring device are disposed upstream and downstream of an electrolyte outlet of a battery stack, respectively, and the first laser measuring device and the second laser measuring device are spaced apart by a preset distance denoted as L. A first feedback signal SI and a second feedback signal S2 of laser light incident on the electrolyte are acquired by the first laser measuring device and the second laser measuring device, and a cross-correlation operation is performed with respect to the first feedback signal SI and the second feedback signal S2 so that a correlation function can be obtained:

$$R ( τ ) = {lim}_{T \to ∞} \frac{1}{T} {\int }_{0}^{t} {S}_{1} ( t ) {S}_{2} ( t + τ ) dt$$

A time t taken for the electrolyte from the upstream to the downstream is solved according to the obtained correlation function. A flow speed Vins=L/t of the electrolyte is determined according to the solved time t and the distance L between the first laser measuring device and the second laser measuring device. In the embodiment of the present disclosure, an instantaneous flow rate Qins of the electrolyte can be determined according to the determined flow speed Vins of the electrolyte and the pipe cross-sectional area Sstack, where Qins=pipe cross-sectional area Sstack*flow speed Vins.

In the embodiment of the present disclosure, real-time detection of the flow speed Vins and the flow rate Qᵢₙₛ of the electrolyte entering and exiting the stack is implemented by means of the two laser measuring devices distributed upstream and downstream, and the flow speed and the flow rate of the electrolyte are determined by means of non-contact detection technology of laser measurement and correlation method operation, thereby improving the interference resistance of the strategy system and the accuracy of the measurement result.

In an illustrative example, after determining the instantaneous flow rate of the electrolyte, the method according to the embodiment of the present disclosure further includes:
according to the determined flow rate of the electrolyte, performing closed-loop control on a circulation pump by using a preset operation and control policy to adjust a flow rate of the electrolyte entering and exiting a stack. Here, the circulation pump refers to a device for controlling the flow rate of the electrolyte entering and exiting the stack in the flow battery system, and the operation and control strategy for controlling the circulation pump may include a PID control strategy in the related art.

In the embodiment of the present disclosure, the detected flow rate of the electrolyte may be used as an input signal, and the circulating pump may be controlled in the closed loop by the preset calculation and control strategy, so that the flow rate of the electrolyte entering and exiting the stack may be dynamically adjusted in real time, and the electrolyte is stabilized at an ideal flow rate required for the reaction of the battery stack, thereby maintaining the efficient operation of the battery stack and extending the mechanical life of each component inside the battery stack.

In an illustrative example, after determining the instantaneous flow rate of the electrolyte, the method according to the embodiment of the present disclosure further includes:
dividing the instantaneous void volume by the instantaneous flow rate to obtain an instantaneous void fraction of the electrolyte.

The instantaneous void fraction in the embodiment of the present disclosure is also referred to as cross-sectional porosity, porosity or cross-sectional gas content. The principle of determining the void fraction by the first laser measuring device in the embodiment of the present disclosure is that a particle size distribution is measured according to a physical phenomenon that bubbles can scatter laser light; the laser light has good monochromaticity and strong directivity, so that the laser light is irradiated to an infinitely distant place in an infinite space without obstacles and there is little divergence in the propagation process; and the intensity of the scattered light represents the particle size, i.e., the number of bubbles. By measuring the light intensity of the scattered light at different angles, the distribution of bubbles in the electrolyte can be obtained. The photodetector in the embodiment of the present disclosure implements the function of converting light into electricity in an optical communication system, which is mainly based on a photovoltaic effect of a semiconductor material. The so-called photovoltaic effect refers to a phenomenon in which light is irradiated to generate a potential difference between different portions of inhomogeneous semiconductor or of a combination of semiconductor and metal. It refers to a physical phenomenon in which the conductivity of an irradiated material is changed due to radiation. Photons act on a photo-conductive material to form intrinsic absorption or impurity absorption, and generate additional photo-generated carriers, thereby changing the conductivity of the semiconductor and generating a photo-conductive effect (the photo-conductive effect refers to a phenomenon in which electrons absorb photon energy and transition from a bonding state to a free state under the action of light, causing a change in the conductivity of the material. That is, when light is irradiated on a photoconductor, if the photoconductor is an intrinsic semiconductor material and the light radiation energy is strong enough, the electrons in the valence band of the photoelectric material will be excited to the conduction band, thereby increasing the conductivity of the photoconductor).

In the embodiment of the present disclosure, the instantaneous void volume and the instantaneous void fraction in the electrolyte are detected in real time by means of the laser measuring devices, so that the status of the electrolyte can be monitored in real time. Also, the instantaneous void volume and the instantaneous void fraction can reflect the instantaneous status of charge and discharge of the battery stack, and whether a reaction such as hydrogen evolution occurs can be monitored in real time.

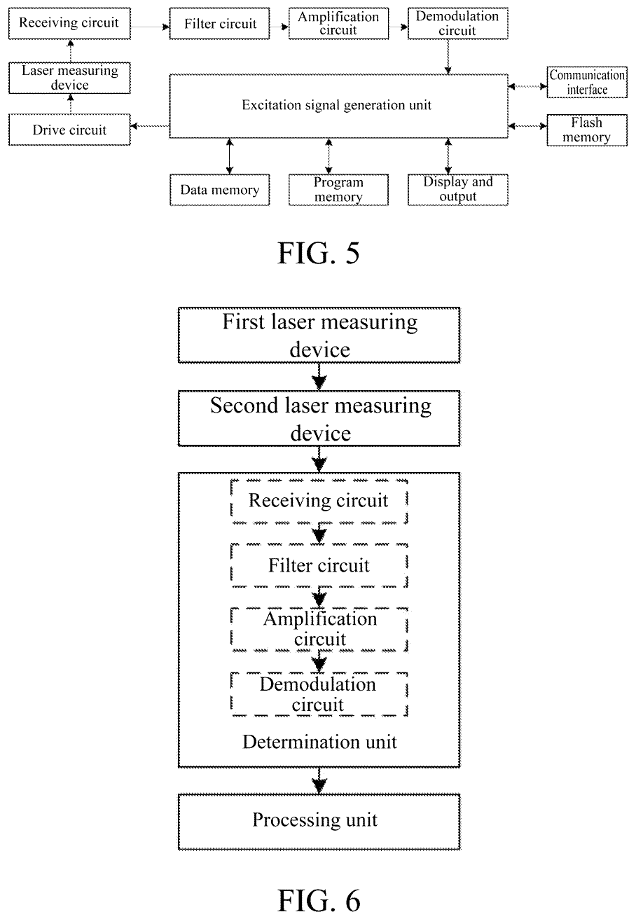

In an illustrative example, the embodiment of the present disclosure is used in a system for implementing electrolyte monitoring to implement the method described above. With reference to FIG. 5, the system includes an excitation signal generation unit, a drive circuit for laser measuring devices, two laser measuring devices 4 (which are a first laser measuring device and a second laser measuring device, respectively, each laser measuring device 4 including a laser 4-1, a spatial filter 4-2, a collimator lens 4-3, a Fourier lens 4-4, and a photodetector 4-5), a receiving circuit, a filter circuit, an amplification circuit, a demodulation circuit, and the like,

In the embodiment of the present disclosure, with a single-chip ARM processor STM32 serving as the excitation signal generation unit as an example, the single-chip ARM processor STM32 generates a pulse signal by means of internal clock oscillation. A pulse current is output as an excitation signal to the drive circuit through a digital-to-analog converter (DAC) and a direct memory access (DMA) configuration. The drive circuit amplifies the power of the pulse current, the laser 4-1 is driven by the pulse current with the amplified power, and the laser 4-1 generates laser light according to the received pulse current.

In an illustrative example, the above-mentioned system according to the embodiment of the present disclosure may further include one or any combination of the following: a communication interface, a data memory, a flash memory (FLASH), a program memory, display and output, etc., and the specific composition may be set by those skilled in the art according to an application scenario.

In the embodiments of the present disclosure, the non-contact measurement of the flow speed and bubble content of a fluid is simultaneously implemented by means of the laser measuring devices, and the leakage of the electrolyte due to the sealing problem is avoided. The flow speed of the electrolyte is calculated by the correlation method so that the accuracy of calculating the speed is improved, and the interference resistance is strong. The operation condition, the remaining life and the health condition of the battery stack can be analyzed and obtained on the basis of the real-time detection of the flow speed and bubble content of the electrolyte with reference to the related technology. Estimation is performed by means of a preset algorithm, which provides data support for early intervention in the operation and maintenance of the battery stack, thereby reducing the operation risk and operation and maintenance cost of the battery stack.

An embodiment of the present disclosure further provides a computer storage medium, storing a computer program therein, wherein when the computer program is executed by a processor, the method for implementing electrolyte monitoring described above is implemented.

An embodiment of the present disclosure further provides a terminal, including a memory and a processor, a computer program being saved in the memory, wherein
the processor is configured to execute the computer program in the memory; and
when the computer program is executed by the processor, the method for implementing electrolyte monitoring described above is implemented.

FIG. 6 is a structural block diagram of a system for implementing electrolyte monitoring according to an embodiment of the present disclosure. As shown in FIG. 6, the system includes a first laser measuring device, a determination unit, and a processing unit, wherein
the first laser measuring device is disposed in advance at a position where an electrolyte can be measured, and configured to acquire an electrical signal including light intensity information, the light intensity information including information of light intensity of laser light scattered after passing through the electrolyte including bubbles;
the determination unit is configured to determine a bubble particle size distribution function according to the acquired electrical signal; and
the processing unit is configured to calculate an instantaneous void volume of the electrolyte according to the determined bubble particle size distribution function.

In an embodiment of the present disclosure, a first laser measuring device is provided to acquire the information of light intensity of laser light scattered after passing through the electrolyte, the bubble particle size distribution function is determined by means of the acquired electrical signal, the instantaneous bubble volume of the electrolyte is calculated by means of the determined bubble particle size distribution function, enabling a gas content of an electrolyte in a flow battery system to be monitored.

In an illustrative example, the determination unit in the embodiment of the present disclosure is configured to:
pre-processing and demodulating the electrical signal to obtain a demodulated signal; and
determining the bubble particle size distribution function according to the obtained demodulated signal.

In an illustrative example, the pre-processing of the embodiment of the present disclosure may include filtering and amplification. Here, the pre-processing performed on the electrical signal may be implemented by those skilled in the art with reference to the related principle of signal processing. The pre-processing is mainly performed to reduce noise and interference and amplify an effective signal, and the processing accuracy and quality of the signal may be improved by means of the pre-processing.

In an illustrative example, the determination unit in an embodiment of the present disclosure includes a receiving circuit, a filter circuit, an amplification circuit, and a demodulation circuit, wherein
the receiving circuit is configured to receive an electrical signal;
the filter circuit is configured to perform filtering processing on the received electrical signal;
the amplification circuit is configured to amplify the filtered electrical signal; the demodulation circuit is configured to demodulate the amplified and filtered electrical signal into a demodulated signal;
a bubble particle size distribution function is determined according to the obtained demodulated signal.

In an illustrative example, the instantaneous void volume in the embodiment of the present disclosure is sins, and the processing unit is configured to calculate the instantaneous void volume by the following calculation formula:

$$ε ins = n ( R ) \cdot V = n ( R ) \cdot ( 4 / 3 ) π {R}^{3} ;$$

where n(R) is a particle size distribution function of bubbles, R is the radius of a bubble particle, V is a volume of the bubble particle, and the included angle formed by the propagation direction of scattered light after the laser light is refracted and the propagation direction of a principal light beam is θ, and θ and the radius R of the bubble particle in the electrolyte satisfy:

$$I ( θ ) = \frac{1}{θ} {\int }_{0}^{1} {R}^{2} * n ( R ) {J}_{1}^{2} ( θ RK ) dR ,$$

where I(θ) is the light intensity of the laser light scattered at an angle θ, K=2π/λ, λ is the wavelength of the laser light, and JI is a Bayesian function of a first type.

In an illustrative example, the first laser measuring device in the embodiment of the present disclosure may be disposed at any one of the following positions:
a tube wall of an electrolyte inlet tube of a battery stack;
a tube wall of an electrolyte outlet tube of the battery stack; and
on a branch tube wall of a main inlet and outlet tube of the electrolyte.

In an illustrative example, the system according to an embodiment of the present disclosure further includes a second laser measuring device disposed upstream or downstream of the first laser measuring device, and the first laser measuring device and the second laser measuring device are spaced apart from each other by a preset distance, where the preset distance is denoted as L.

The first laser measuring device and the second laser measuring device acquire a first feedback signal SI and a second feedback signal S2 of laser light incident on the electrolyte.

In the embodiment of the present disclosure, the processing unit is further configured to:
perform a cross-correlation operation with respect to the first feedback signal SI and the second feedback signal S2 so that a correlation function can be obtained:

$$R ( τ ) = {lim}_{T \to ∞} \frac{1}{T} {\int }_{0}^{t} {S}_{1} ( t ) {S}_{2} ( t + τ ) dt$$

solve a time t taken for the electrolyte from upstream to downstream according to the obtained correlation function; and
according to the solved time t and the distance L between the first laser measuring device and the second laser measuring device, determine a flow speed Vins=L/t of the electrolyte.

In an illustrative example, the processing unit according to the embodiment of the present disclosure may further be configured to determine an instantaneous flow rate Qins of the electrolyte according to the determined flow speed Vins of the electrolyte and the pipe cross-sectional area Sstack, where Qins=pipe cross-sectional area Sstack*flow speed Vins.

In the embodiment of the present disclosure, real-time detection of the flow speed Vins and the flow rate Qᵢₙₛ of the electrolyte entering and exiting the stack is implemented by means of the two laser measuring devices distributed upstream and downstream, and the flow speed and the flow rate of the electrolyte are determined by means of non-contact detection technology of laser measurement and correlation method operation, thereby improving the interference resistance of the strategy system and the accuracy of the measurement result.

In an illustrative example, the processing unit according to the embodiment of the present disclosure is further configured to obtain an instantaneous void fraction of the electrolyte by dividing the instantaneous void volume by the instantaneous flow rate.

In the embodiment of the present disclosure, the instantaneous void volume and the instantaneous void fraction in the electrolyte are detected in real time by means of the laser measuring devices, so that the status of the electrolyte can be monitored in real time. Also, the instantaneous void volume and the instantaneous void fraction can reflect the instantaneous status of charge and discharge of the battery stack, and whether a reaction such as hydrogen evolution occurs can be monitored in real time.

In an illustrative example, the processing unit according to the embodiment of the present disclosure is further configured to:
according to the determined instantaneous flow rate, perform closed-loop control on a circulation pump by using a preset operation and control policy to adjust a flow rate of the electrolyte entering and exiting a stack.

In the embodiment of the present disclosure, the detected flow rate of the electrolyte may be used as an input signal, and the circulating pump may be controlled in the closed loop by the preset calculation and control strategy, so that the flow rate of the electrolyte entering and exiting the stack may be dynamically adjusted in real time, and the electrolyte is stabilized at an ideal flow rate required for the reaction of the battery stack, thereby maintaining the efficient operation of the battery stack and extending the mechanical life of each component inside the battery stack.

It can be understood by those of ordinary skill in the art that, all or some of the steps in the methods, and functional modules/units in the systems and devices disclosed above may be implemented as software, firmware, hardware, and suitable combinations thereof. In a hardware implementation, the division between the functional modules/units mentioned in the above description does not necessarily correspond to the division of physical components. For example, one physical component may have a plurality of functions, or one function or step may be performed by several physical components in cooperation with each other. Some or all of the components may be implemented as software executed by a processor such as a digital signal processor or a microprocessor, or as hardware, or as an integrated circuit such as an application-specific integrated circuit. Such software may be distributed on a computer-readable medium, which may include a computer storage medium (or a non-transitory medium) and a communication medium (or a transitory medium). As is well known to those of ordinary skill in the art, the term “computer storage medium” includes volatile and nonvolatile, removable and non-removable media implemented in any method or technology for storage of information (such as computer readable instructions, data structures, program modules or other data). The computer storage medium includes, but is not limited to, a RAM, a ROM, an EEPROM, a flash memory or other memory technology, a CD-ROM, a digital versatile disk (DVD) or other optical disk storage, a magnetic cassette, a magnetic tape, a magnetic disk storage or other magnetic storage devices, or any other medium which can be used to store desired information and which can accessed by a computer. Further, as is well known to those of ordinary skill in the art, the communication medium typically includes computer-readable instructions, data structures, program modules or other data in a modulated data signal such as a carrier wave or other transmission mechanism, and may include any information delivery media.

1. A method for implementing electrolyte monitoring, characterized by comprising:
acquiring an electrical signal comprising light intensity information by a first laser measuring device that is disposed in advance, the light intensity information comprising information of light intensity of laser light scattered after passing through an electrolyte containing bubbles;
determining a bubble particle size distribution function according to the acquired electrical signal; and
calculating an instantaneous void volume of the electrolyte according to the determined bubble particle size distribution function;
wherein the first laser measuring device is disposed at a position where the scattered light intensity of the laser light passing through the electrolyte can be measured.

2. The method according to claim 1, wherein determining bubble particle size distribution function information according to the acquired electrical signal comprises:
pre-processing and demodulating the electrical signal to obtain a demodulated signal; and
determining the bubble particle size distribution function according to the obtained demodulated signal.

3. The method according to claim 2, wherein the pre-processing comprises filtering and amplification.

4. The method according to claim 1, wherein the instantaneous void volume is sins, and the instantaneous void volume is calculated by the following calculation formula:
$$ε ins = n ( R ) \cdot V = n ( R ) \cdot ( 4 / 3 ) π {R}^{3} ;$$
where n(R) is a particle size distribution function of bubbles, R is a radius of a bubble particle, V is a volume of the bubble particle, and an included angle formed by a propagation direction of scattered light after the laser light is refracted and a propagation direction of a principal light beam is θ, and θ and the radius R of the bubble particle in the electrolyte satisfy:
$$I ( θ ) = \frac{1}{θ} {\int }_{0}^{1} {R}^{2} * n ( R ) {J}_{1}^{2} ( θ RK ) dR ,$$
where I(θ) is the light intensity of the laser light scattered at an angle θ, K=2π/λ, λ is a wavelength of the laser light, and JI is a Bayesian function of a first type.

5. The method according to claim 1, wherein the first laser measuring device is disposed at any one of the following positions:
a tube wall of an electrolyte inlet tube of a battery stack;
a tube wall of an electrolyte outlet tube of the battery stack; and
on a branch tube wall of a main inlet and outlet tube of the electrolyte.

6. The method according to claim 1, further comprising:
acquiring a first feedback signal of laser light incident on the electrolyte by the first laser measuring device;
acquiring a second feedback signal of the laser light incident on the electrolyte by a second laser measuring device that is disposed in advance;
performing a cross-correlation operation with respect to the first feedback signal and the second feedback signal, and solving a time taken for displacement of the electrolyte from upstream to downstream according to a correlation function obtained by the cross-correlation operation; and
according to the time taken for displacement of the electrolyte from upstream to downstream and a spacing between the first laser measuring device and the second laser measuring device, determining a flow speed of the electrolyte;
wherein the second laser measuring device is disposed upstream or downstream of the first laser measuring device, and the first laser measuring device and the second laser measuring device are spaced apart by a preset distance.

7. The method according to claim 6, wherein after determining the flow speed of the electrolyte, the method further comprises:
according to the determined flow speed of the electrolyte and a predetermined pipe cross-sectional area, determining an instantaneous flow rate of the electrolyte.

8. The method according to claim 7, wherein after determining the instantaneous flow rate of the electrolyte, the method further comprises:
dividing the instantaneous void volume by the instantaneous flow rate to obtain an instantaneous void fraction of the electrolyte.

9. The method according to claim 7, wherein after determining the instantaneous flow rate of the electrolyte, the method further comprises:
according to the determined instantaneous flow rate, performing closed-loop control on a circulation pump by using a preset operation and control policy to adjust a flow rate of the electrolyte entering and exiting a stack.

10. A computer storage medium, storing a computer program therein, wherein when the computer program is executed by a processor, the method for implementing electrolyte monitoring according to claim 1 is implemented.

11. A terminal, comprising a memory and a processor, a computer program being saved in the memory, wherein
the processor is configured to execute the computer program in the memory; and
when the computer program is executed by the processor, the method for implementing electrolyte monitoring according to claim 1 is implemented.

12. A system for implementing electrolyte monitoring, comprising a first laser measuring device, a determination unit and a processing unit, wherein
the first laser measuring device is disposed in advance at a position where scattered light intensity of laser light passing through an electrolyte can be measured, and configured to acquire an electrical signal comprising light intensity information, the light intensity information comprising information of light intensity of the laser light scattered after passing through the electrolyte containing bubbles;
the determination unit is configured to determine a bubble particle size distribution function according to the acquired electrical signal; and
the processing unit is configured to calculate an instantaneous void volume of the electrolyte according to the determined bubble particle size distribution function.
